(19) United States
(12) Patent Application Publication
(10) Pub. No.: US 2024/0166437 A1
(43) Pub. Date: May 23, 2024

(54) AN AUTOMATED STORAGE SYSTEM

(71) Applicant: Autostore Technology AS, Nedre Vats (NO)

(72) Inventor: Trond Austrheim, Etne (NO)

(73) Assignee: Autostore Technology AS, Nedre Vats (NO)

(21) Appl. No.: 18/279,698

(22) PCT Filed: Feb. 18, 2022
(86) PCT No.: PCT/EP2022/054107

§ 371 Date: Sep. 1, 2023

(30) Foreign Application Priority Data
Mar. 1, 2021 (NO) 20210275
Mar. 9, 2021 (NO) 20210308
May 27, 2021 (NO) 20210675
Jun. 4, 2021 (NO) 20210715

(51) Int. Cl. B65G 1/04; F25D 17/00; F25D 25/04

(52) U.S. Cl. CPC B65G 1/0464; F25D 17/005; F25D 25/04; B65G 2201/0235

(57) ABSTRACT

A framework structure for a storage system includes a plurality of vertical column profiles and a horizontal rail system supported upon the vertical column profiles. At least a lower section of each of the column profiles is thermally divided from the rail system by a thermal break positioned at each column profile between a lower section of the column profile and a connection to the rail system. The thermal break is configured to restrict thermal conductivity between the lower section of the column profile and the rail system.

### FIELD OF THE INVENTION

The present invention relates to a storage system in which a rail system for container handling vehicles is thermally insulated from a below-arranged low-temperature section.

### BACKGROUND AND PRIOR ART

FIG. 1 discloses a prior art automated storage and retrieval system 1 with a framework structure 100 and FIGS. 2, 3 and 4 disclose three different prior art container handling vehicles 201,301,401 suitable for operating on such a system 1.

The framework structure 100 comprises upright members 102 and a storage volume comprising storage columns 105 arranged in rows between the upright members 102. In these storage columns 105 storage containers 106, also known as bins, are stacked one on top of one another to form stacks 107. The members 102 may typically be made of metal, e.g. extruded aluminium profiles, and may alternatively be termed vertical column profiles.

The framework structure 100 of the automated storage and retrieval system 1 comprises a rail system 108 (i.e. a rail grid) arranged across the top of framework structure 100, on which rail system 108 a plurality of container handling vehicles 201,301,401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201,301,401 in a first direction X across the top of the frame structure 100, and a second set of parallel rails 111 arranged perpendicular to the first set of rails 110 to guide movement of the container handling vehicles 201,301,401 in a second direction Y which is perpendicular to the first direction X. Containers 106 stored in the columns 105 are accessed by the container handling vehicles 201,301,401 through access openings 112 in the rail system 108. The container handling vehicles 201,301,401 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supportive.

Each prior art container handling vehicle 201,301,401 comprises a vehicle body 201a,301a,401a and first and second sets of wheels 201b,201c,301b,301c,401b,401c which enable the lateral movement of the container handling vehicles 201,301,401 in the X direction and in the Y direction, respectively. In FIGS. 2, 3 and 4 two wheels in each set are fully visible. The first set of wheels 201b,301b,401b is arranged to engage with two adjacent rails of the first set 110 of rails, and the second set of wheels 201c,301c,401c is arranged to engage with two adjacent rails of the second set 111 of rails. At least one of the sets of wheels 201b,201c,301b,301c,401b,401c can be lifted and lowered, so that the first set of wheels 201b,301b,401b and/or the second set of wheels 201c,301c,401c can be engaged with the respective set of rails 110, 111 at any one time.

Each prior art container handling vehicle 201,301,401 also comprises a lifting device for vertical transportation of storage containers 106, e.g. raising a storage container 106 from, and lowering a storage container 106 into, a storage column 105. The lifting device comprises one or more gripping/engaging devices which are adapted to engage a storage container 106, and which gripping/engaging devices can be lowered from the vehicle 201,301,401 so that the position of the gripping/engaging devices with respect to the vehicle 201,301,401 can be adjusted in a third direction Z which is orthogonal the first direction X and the second direction Y. Parts of the gripping device of the container handling vehicles 301,401 are shown in FIGS. 3 and 4 indicated with reference number 304,404. The gripping device of the container handling device 201 is located within the vehicle body 201a in FIG. 2.

Conventionally, and also for the purpose of this application, Z=1 identifies the uppermost layer of storage containers, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=17, Y=1, Z=6. The container handling vehicles 201,301,401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid 104, where the possible storage positions within this grid are referred to as storage cells. Each storage column may be identified by a position in an X- and Y-direction, while each storage cell may be identified by a container number in the X-, Y- and Z-direction.

Each prior art container handling vehicle 201,301,401 comprises a storage compartment or space for receiving and stowing a storage container 106 when transporting the storage container 106 across the rail system 108. The storage space may comprise a cavity arranged internally within the vehicle body 201a as shown in FIGS. 2 and 4 and as described in e.g. WO2015/193278A1 and WO2019/206487A1, the contents of which are incorporated herein by reference.

FIG. 3 shows an alternative configuration of a container handling vehicle 301 with a cantilever construction. Such a vehicle is described in detail in e.g. NO317366, the contents of which are also incorporated herein by reference.

The cavity container handling vehicles 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the cavity container handling vehicles 401 may have a footprint which is larger than the lateral area defined by a storage column 105 as shown in FIGS. 1 and 4, e.g. as is disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing.

These grooves and upwardly protruding elements are collectively known as tracks. Each rail may comprise one track, or each rail may comprise two parallel tracks. Each rail may be provided by two parallel track members which are fastened together, each track member providing one of the tracks for a two track rail.

WO2018/146304A1, the contents of which are incorporated herein by reference, illustrates a typical configuration of rail system 108 comprising rails and parallel tracks in both X and Y directions forming a rail grid.

In the framework structure 100, most of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201,301,401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or dedicated column 105 within the framework structure 100, then picked up by any container handling vehicle and transported to a port column 119,120 for further transportation to an access station. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201,301 can drop off storage containers 106 to be transported to an access or a transfer station, and the second port column 120 may be a dedicated pick-up port column where the container handling vehicles 201,301,401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1 but are returned into the framework structure 100 again once accessed. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119,120 and the access station.

If the port columns 119,120 and the access station are located at different levels, the conveyor system may comprise a lift device with a vertical component for transporting the storage containers 106 vertically between the port column 119,120 and the access station.

The conveyor system may be arranged to transfer storage containers 106 between different framework structures, e.g. as is described in WO2014/075937A1, the contents of which are incorporated herein by reference.

When a storage container 106 stored in one of the columns 105 disclosed in FIG. 1 is to be accessed, one of the container handling vehicles 201,301,401 is instructed to retrieve the target storage container 106 from its position and transport it to the drop-off port column 119. This operation involves moving the container handling vehicle 201,301 to a location above the storage column 105 in which the target storage container 106 is positioned, retrieving the storage container 106 from the storage column 105 using the container handling vehicle's 201,301,401 lifting device (not shown), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201,301,401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201,301,401 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201,301,401 positions the storage container 106 at the desired position. The removed storage containers 106 may then be lowered back into the storage column 105 or relocated to other storage columns 105.

For monitoring and controlling the automated storage and retrieval system 1, e.g. monitoring and controlling the location of respective storage containers 106 within the framework structure 100, the content of each storage container 106; and the movement of the container handling vehicles 201,301,401 so that a desired storage container 106 can be delivered to the desired location at the desired time without the container handling vehicles 201,301,401 colliding with each other, the automated storage and retrieval system 1 comprises a control system 500 which typically is computerized and which typically comprises a database for keeping track of the storage containers 106.

The prior art storage systems described above may also be used for freezing and/or cooling of stored items. WO 2015/124610 A1 discloses a storage system, see FIG. 5, configured for cooling items stored in the stacked storage containers 106. The storage system may feature insulated lids (not shown) arranged at the upper end of each storage column 105 to insulate the storage containers from the surroundings above. A potential problem of having a lower section of the framework structure 100 at a low temperature required for freezing or cooling stored items, is that conductive cooling of the rail system 108 via the vertical column profiles 102 may cause water condensation and even ice formation on the rails 110,111. Water and/or ice on the rails may cause problems, e.g. loss of wheel traction, for the container handling vehicles 201,301,401 operating thereupon.

An object of the present invention is to provide an improved framework structure for a cooled storage system.

### SUMMARY OF THE INVENTION

The present invention is defined by the attached claims and in the following:

In a first aspect, the present invention provides A framework structure for a storage system, the framework structure comprises a plurality of vertical column profiles and a horizontal rail system supported upon the vertical column profiles, wherein at least a lower section of each of the column profiles is thermally divided from the rail system by a thermal break positioned at each column profile between a lower section of the column profile and a connection to the rail system, the thermal break being configured to restrict thermal conductivity between the lower section of the column profile and the rail system.

In other words, the thermal break is configured to restrict thermal conductivity between at least the lower section of the column profile and the rail system to which the column profile is connected.

In an embodiment of the framework structure, the column profiles and optionally at least parts of the rail system may be made in an aluminium alloy, and the thermal break may comprise a thermal break material having a thermal conductivity lower than 20 W/mK.

The thermal break material may have a thermal conductivity lower than 10 W/mK, lower than 5 W/mK or preferably lower than 1 W/mK.

The aluminium alloy may have a thermal conductivity between 115-226 W/mK and may belong to the 6000 or 7000 series of aluminium alloys. The ratio of the thermal conductivity of the thermal break material and the thermal conductivity of the aluminium alloy may be in the range of 0.2-0.001.

In an embodiment of the framework structure, the thermal break material may be a synthetic polymer or wood. The synthetic polymer may advantageously be selected from various types of polyvinyl chloride (PVC), high-density polyethylene (HDPE), polypropylene (PP) and acrylonitrile-butadiene-styrene (ABS).

The thermal break may be configured such that the maximum conductive transfer of heat, or the maximum thermal conductivity, between a lower section of the column profile and the rail system is substantially equal to the thermal conductivity of the thermal break material. In other words, at least the parts of the thermal break being in thermal conductive contact with both the lower section of the column profile and the rail system is made in the thermal break material.

The thermal break may comprise additional layers, for example, as a sandwich construction, where the material providing the thermal isolation, i.e. the thermal break material, is sandwiched between other layers offering other properties, for example, increased strength and/or toughness to assist with the load transfer from the rail system above down through the vertical column. Alternatively, layers of the thermal break material may have the other layers sandwiched between them.

In an embodiment of the framework structure, the thermal break may be configured such that heat being conducted between the lower section of the column profile and the rail system must pass through the thermal break material.

In an embodiment of the framework structure, the thermal break may comprise a horizontal plate arranged between the rail system and at least the lower section of the column profiles. The horizontal plate may be made in the thermal break material. The horizontal plate conductively separates the rail system from at least the lower section of the column profile and may alternatively be termed a separation plate.

In an embodiment of the framework structure, the horizontal plate of each thermal break may extend transversely to the column profiles, at a common height arranged between the rail system and at least the lower section of the column profiles.

In an embodiment of the framework structure, the thermal break may comprise vertical protrusions, the vertical protrusions may be arranged to interact with a surface of the column profile or the rail system to restrict horizontal movement between the thermal break and the column profile or the rail system, respectively. The surfaces of the column profile or the rail system, with which the vertical protrusions interact, may be substantially vertical surfaces. The vertical protrusions may extend from the horizontal plate of the thermal break.

The vertical protrusions may be in any shape or form, such as pins or ribs, provided they are suitable for restricting the horizontal movement between the thermal break and the column profile or the rail system.

In an embodiment of the framework structure, the vertical protrusions are configured to prevent horizontal movement between the thermal break and the rail system, the vertical protrusions may extend into corresponding recesses at a downwards facing portion of the rail system or arranged at opposite sides of at least one rail.

In an embodiment of the framework structure, each of the column profile may have a hollow centre section and four corner sections, each corner section may be defined by a pair of vertically extending, outwardly projecting, perpendicular flanges. The corner sections may alternatively be termed corner spaces. In other words, the column profile has a cross-section comprising a hollow centre section and four corner sections.

The hollow centre section may comprise four vertically extending wall sections. The wall sections may form a substantially square hollow portion of a cross-section of the column profile. Each wall section may feature an external surface and an internal surface. The external surface may be arranged between two corner sections, i.e. arranged between two parallel flanges.

The horizontal plate may comprise a main portion having a periphery equal to the periphery of the cross-section of the hollow centre section

In an embodiment of the framework structure, the thermal break may comprise four corner sections (alternatively corner spaces or corner recesses) fully overlapping the respective four corner sections of the column profile, such that the column profile will have four continuous corner sections extending from the rail system to a lowermost end of the column profile. The four corner sections may be arranged in the horizontal plate.

The horizontal plate may be cross-shaped. A centre or centreline of the cross-shaped plate may be colinear with a centreline of the column profile.

In an embodiment of the framework structure, the thermal break (or horizontal plate) may comprise vertical protrusions arranged to interact with internal or external surfaces of the hollow centre section to restrict horizontal movement between the thermal break and the column profile.

In an embodiment of the framework structure, the thermal break may be arranged at an uppermost end of the column profile, and the rail system is supported on the thermal break.

In an embodiment of the framework structure, the thermal break (or the horizontal plate) may comprise vertical protrusions arranged at opposite sides of at least one rail of the rail system, the vertical protrusions restricting horizontal movement between the thermal break and the rail in a direction perpendicular to the longitudinal direction of the rail. The vertical protrusion may extend upwards from the horizontal plate.

In an embodiment of the framework structure, the column profile may comprise a lower profile section and an upper profile section interconnected via the thermal break.

In an embodiment, the framework structure may comprise a plurality of storage columns in which storage containers may be stacked on top of one another in vertical stacks, each storage column is defined by one corner section from each of four column profiles, the corner sections arranged to accommodate a corner of a storage container, and the thermal break of each column profile (102) is configured to be flush with or recessed from the corner sections of the column profile such that the corner sections are unobstructed between the rail system and a lower end of the storage column.

In a second aspect, the present invention provides a storage system for storage containers, the storage system comprising a framework structure according to any embodiment of the first aspect and a plurality of container handling vehicles arranged to operate upon the rail system.

In an embodiment of the storage system, the vertical column profiles define storage columns in which storage containers are stored on top of one another in vertical stacks.

The container handling vehicles may comprise wheels, allowing them to move in two perpendicular directions upon the rail system, and a lifting device for lowering/raising storage containers into/from the storage columns.

In an embodiment, the storage system may be a cooled storage system and may comprise a cooling system arranged to provide cooled air to a section of the storage system arranged below the rail system. The section of the storage system provided with cooled air may be arranged at a level below the level of the thermal breaks.

In an embodiment of the storage system, the storage columns defined by the column profiles thermally divided from the rail system provide a section of the total number of storage columns in the framework, providing a separate cooled zone within the framework. The cooled zone may be separated from the remaining storage columns of the framework by insulating walls.

In a third aspect, the present invention provides a method of constructing a framework structure for a cooled storage structure, the framework structure comprising a plurality of vertical column profiles and a rail system upon which container handling vehicles may move in two perpendicular directions, the method comprising the steps of:
providing a thermal break for each of the column profiles;
mounting the profile columns to be able to support the rail system;
arranging the thermal breaks at positions to thermally divide at least a lower section of each column profile from the rail system, such that thermal conductivity between at least the lower section of the profile columns and the rail system to be supported by the profile columns is restricted; and
constructing the rail system supported by the profile columns.

The framework structure being constructed by the method according to the third aspect may comprise any of the features of the framework according to the first aspect.

In a fourth aspect, the present invention provides a method of preventing loss of wheel traction of a container handling vehicle operating on a rail system of a cooled storage system, a framework of the cooled storage system comprising a plurality of vertical column profiles upon which the rail system is supported, the method comprises the steps of:
providing a thermal break for each of the column profiles; and
arranging the thermal breaks to thermally divide at least a lower section of each of the column profiles from the rail system, such that thermal conductivity between the lower section of the column profile and the rail system, to which the column profile is connected, is restricted, i.e. such that condensation of water upon the rail system is prevented or minimized.

The thermal break, rail system and column profiles used in the method according to the fourth aspect may comprise any of the features defined in connection with the framework according to the first aspect.

In all aspects of the invention, the vertical column profiles and/or the rail system may be made in an extrudable metal, preferably an aluminium alloy.

The term “thermally divided” is in the present application intended to define that the conductive heat transfer between two structures (that are thermally divided) is restricted or minimized.

The framework structure according to the first aspect may alternatively be defined as comprising a plurality of vertical column profiles and a horizontal rail system supported upon the vertical column profiles, wherein at least a lower section of each of the column profiles is connected to the rail system via a thermal break configured to restrict thermal conductivity between at least the lower section of the column profile and the rail system. In other words, at least a lower section of the column profile may be connected to the rail system via the thermal break, and the thermal break may be positioned at any level between an upper level of the lower section of the column profile and the rail system.

The thermal break may also be termed a thermal break element or thermal break bracket.

### BRIEF DESCRIPTION OF THE DRAWINGS

Embodiments of the invention is described in detail by reference to the following drawings:

FIG. 1 is a perspective view of a framework structure of a prior art automated storage and retrieval system.

FIG. 2 is a perspective view of a prior art container handling vehicle having a centrally arranged cavity for carrying storage containers therein.

FIG. 3 is a perspective view of a prior art container handling vehicle having a cantilevered section for carrying storage containers underneath.

FIG. 4 is a perspective view from below of a prior art container handling vehicle, wherein a container lifting assembly is shown.

FIG. 5 is a side view of a prior art cooled storage system.

FIG. 6 is a topside perspective view of a first exemplary framework structure according to the invention.

FIG. 7 is a topside exploded view of the exemplary framework structure in FIG. 6.

FIG. 8 is an exploded view from below of the exemplary framework structure in FIG. 6.

FIG. 9 is perspective views of a thermal break used in the framework structure in FIGS. 6-8.

FIGS. 10 and 11 are perspective side views of a cooled storage system featuring a second exemplary framework structure according to the invention.

FIG. 12 is an exploded view of a vertical column profile used in the cooled storage system in FIGS. 10 and 11.

FIG. 13 is a perspective view of a thermal break used in the framework structure of the cooled storage system in FIGS. 10 and 11.

### DETAILED DESCRIPTION OF THE INVENTION

In the following, embodiments of the invention will be discussed in more detail with reference to the appended drawings. The drawings are not intended to limit the invention to the illustrated subject-matter.

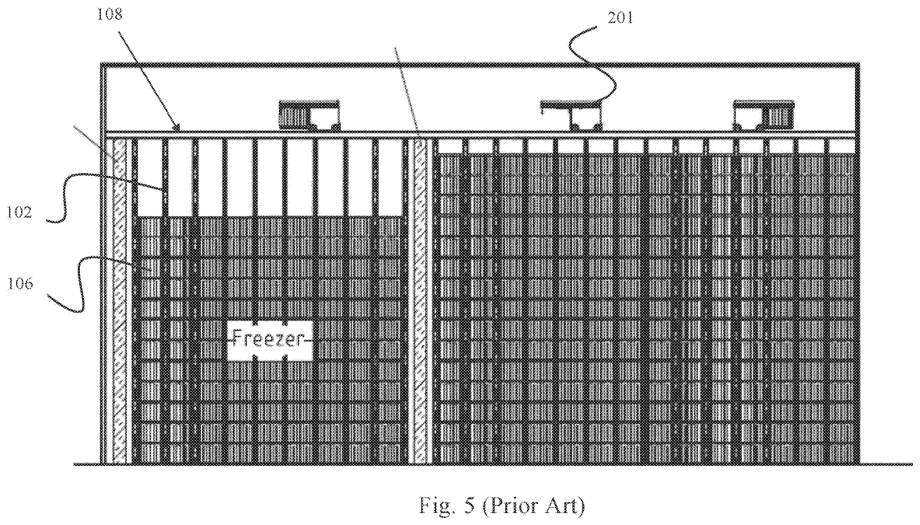

The present invention provides a framework structure for use in a cooled storage system, e.g. a prior art storage system as shown in FIG. 5.

In the prior art storage systems, as well as the framework according to the invention, the column profiles 102 and the rail system 108 are made in a suitable aluminium alloy having a high thermal conductivity. Typical aluminium alloys used in extrusion of structural components, e.g. 6000 and 7000 series alloys, have a thermal conductivity of 115-226 W/mK.

In the prior art cooled storage systems, the high thermal conductivity of the column profiles 102 and the rail system 108 may lead to unwanted cooling of the rail system. If the rail system 108 is in contact with surrounding air kept at e.g. room temperature, condensed water and ice may accumulate upon the rails. Water or ice upon the rails will reduce friction between the wheels of the container handling vehicles operating on the rail system and may also cause derailment of the container handling vehicle. The reduced friction of the wheels may prevent the required exactness by which the container handling vehicles must be controlled to retrieve and store storage containers within the storage system.

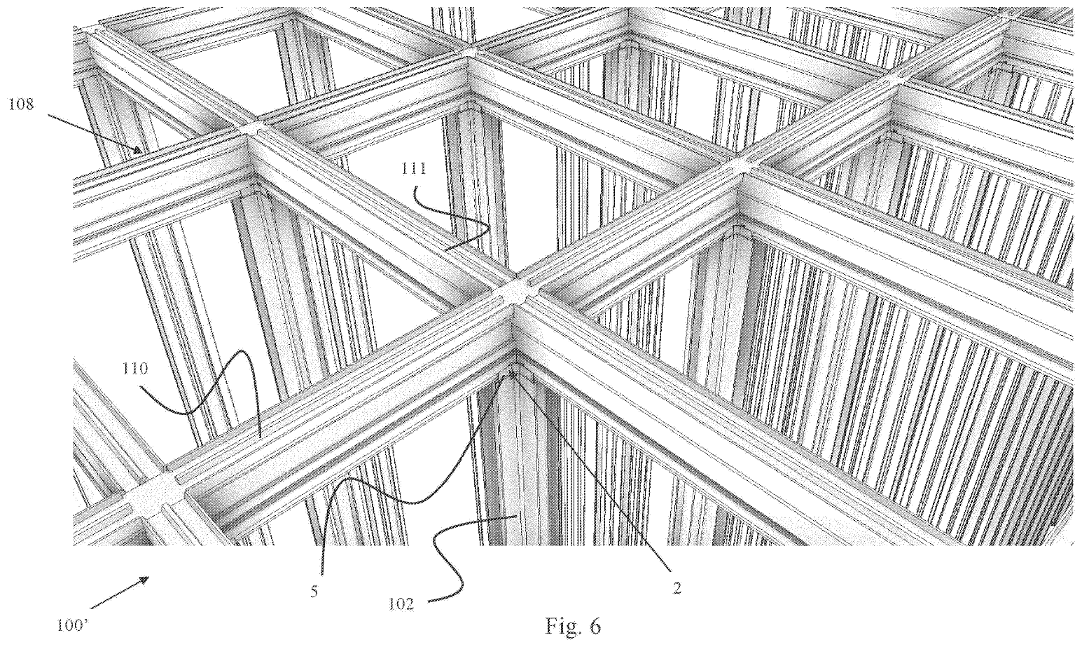

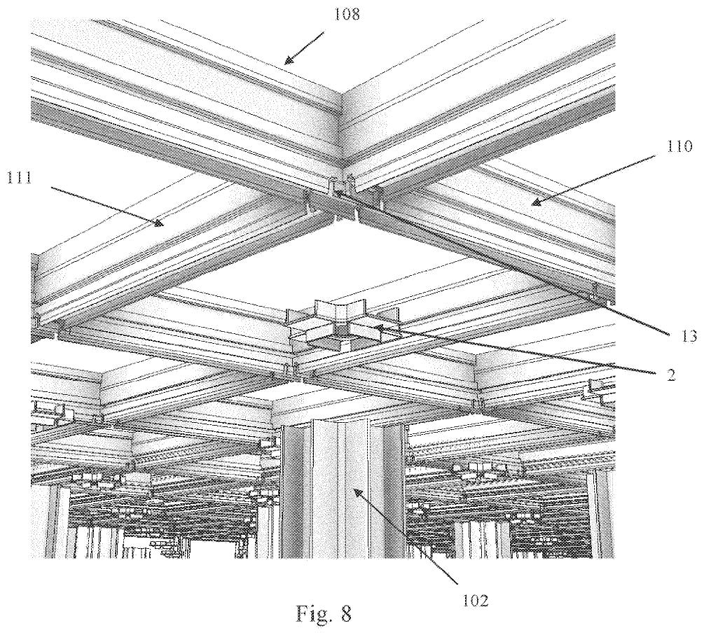

A first exemplary embodiment of a framework structure 100′ according to the invention is shown in FIGS. 6-9.

The framework structure 100′ comprises a plurality of vertical column profiles 102 and a horizontal rail system 108 supported upon the vertical column profiles 102. The column profiles 102 and rail system 108 are made in an aluminium alloy as described for the prior art cooled storage system above. To ensure that thermal conductivity between at least a lower section of the column profiles 102 and the rail system 108 is restricted or minimized, each of the column profiles 102 is thermally divided from the rail system 108 by a thermal break 2. The thermal break 2 is positioned at an uppermost end 10 of the corresponding column profile 102. The rail system 108 is supported on the thermal break 2 and is not in direct contact with the column profiles.

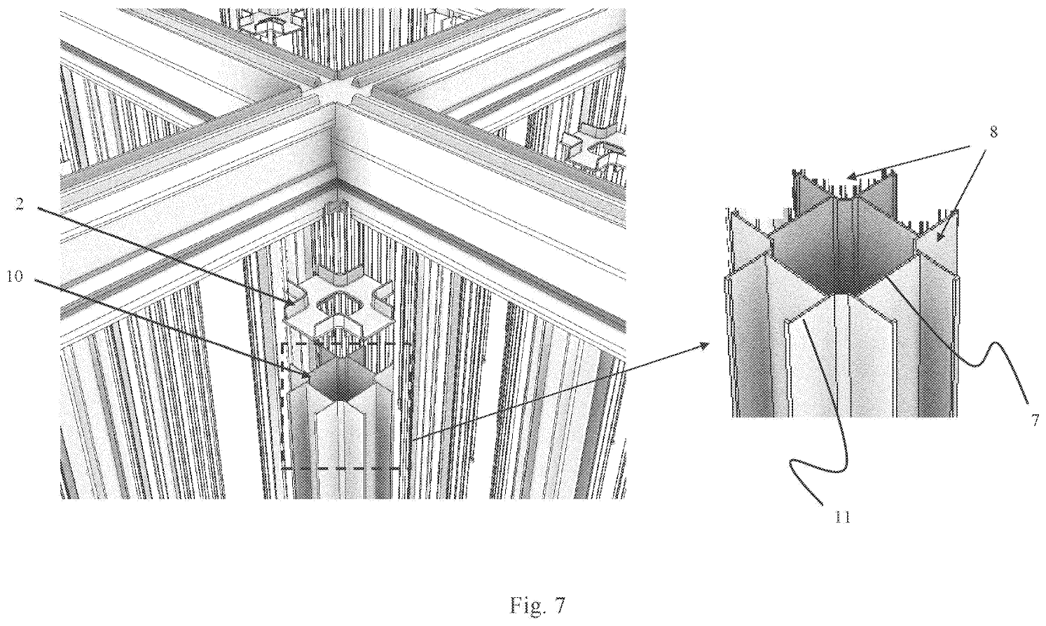

Details of the column profiles are shown in FIG. 7. Each column profile has a hollow centre section 7 and four corner sections 8, each corner section 8 defined by a pair of vertically extending, outwardly projecting, perpendicular flanges 11. The centre section comprises four vertically extending wall element 14. Each wall element 14 arranged between two parallel flanges 11 of two corner sections 8.

In the first exemplary embodiment in FIGS. 6-9, the thermal break is made in a thermal break material having a thermal conductivity lower than 20 W/mK. The thermal conductivity should be as low as possible and may preferably be lower than 1 W/mK. Examples of suitable thermal break materials are synthetic polymers of sufficient strength, such as various types of polyvinyl chloride (PVC), high-density polyethylene (HDPE), polypropylene (PP) and acrylonitrile-butadiene-styrene (ABS). Other thermal break materials, such as various types of wood, may also be used.

The thermal conductivity of a synthetic polymer may be measured according to any of the suitable methods according to ISO 22007-1:2017 or by use of differential scanning calorimetry (DSC) (https://www.mt.com/bk/en/home/supportive content/matchar apps/MatChar UC226.html). The thermal conductivity of wood may be measured according to ASTM 5334.

It is noted that all synthetic polymers and wood will have a thermal conductivity significantly lower than the thermal conductivity of an aluminium alloy suitable for constructing a framework structure according to the invention.

In the first exemplary embodiment, the thermal break 2 is obtained by moulding a suitable synthetic polymer into the desired shape. It is however noted that in other embodiments the thermal break 2 may comprise materials having a high thermal conductivity provided the thermal break is configured such that heat being conducted between a column profile 102 and the rail system 108 must pass through the thermal break material.

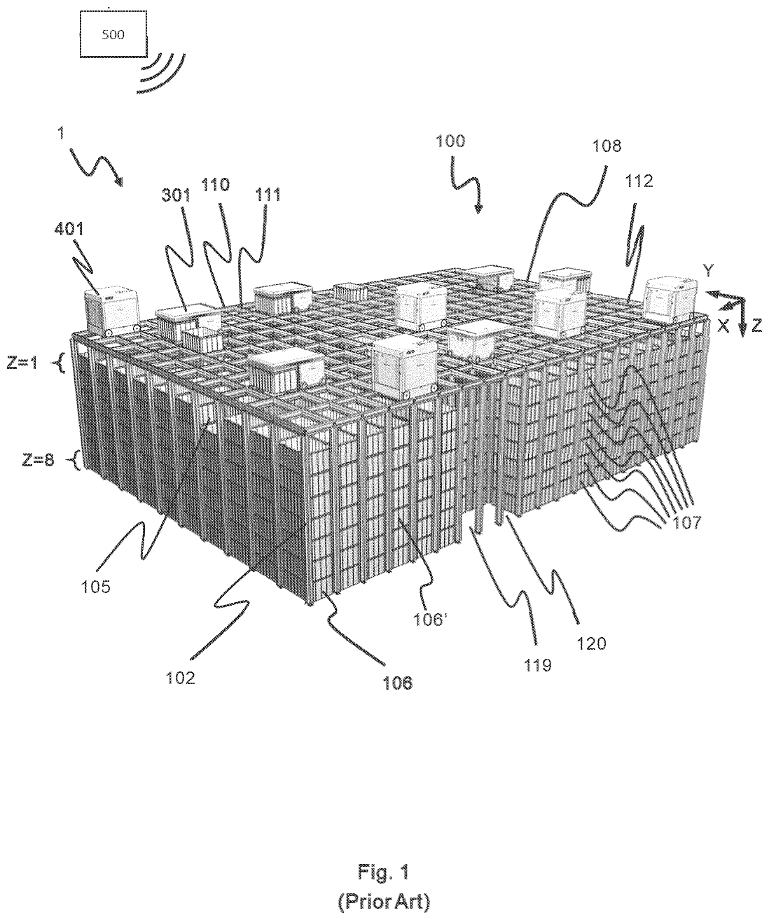

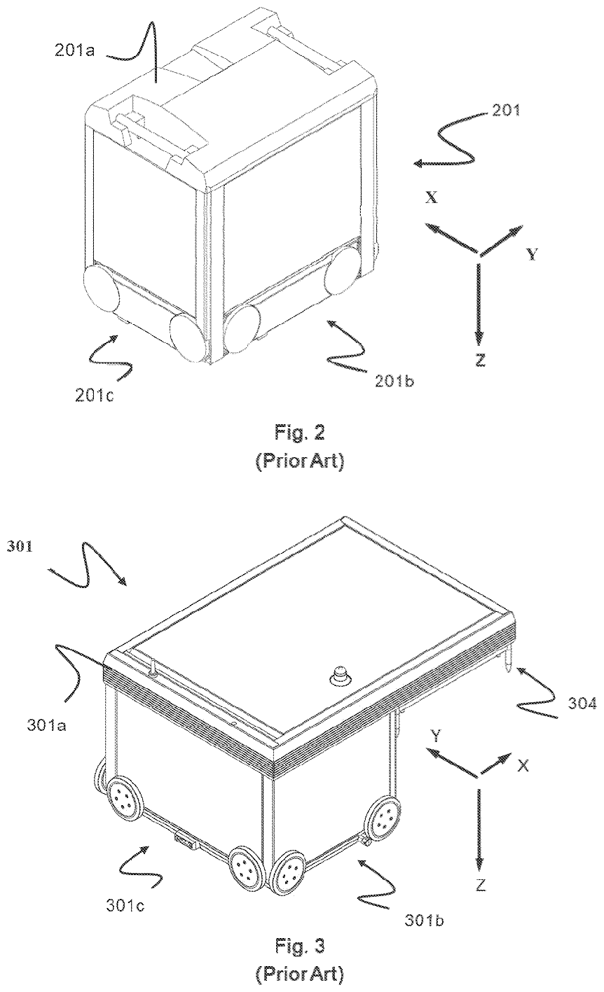

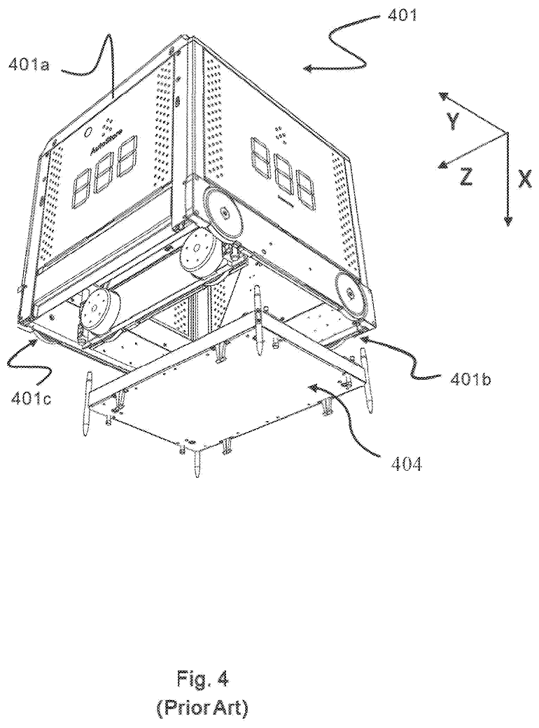

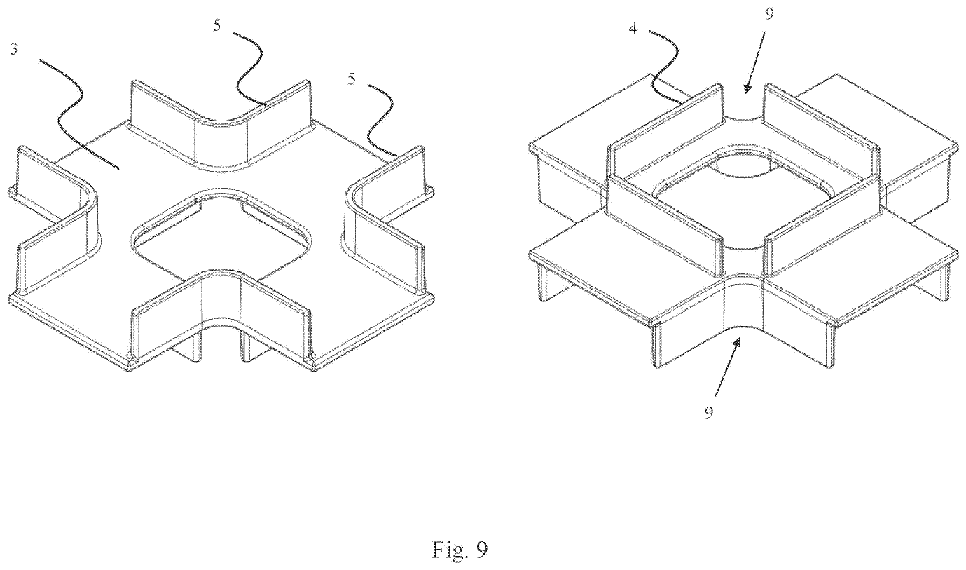

The thermal break 2, see FIG. 9, features a horizontal plate 3 arranged between and separating the rail system 108 and the column profile 102, i.e. between the rail system 108 and at least a lower section of the column profile 102. The horizontal plate 3 of each thermal break 2 extends transversely to the respective column profile. The horizontal plate 3 may also feature four corner sections 9 fully overlapping the respective four corner sections 8 of the column profile 102. In other words, the horizontal plate does not extend into the four corner sections 8 of the column profile 102. When the framework according to the invention is to be used in prior art storage systems as shown in FIGS. 1 and 5 the thermal break should not extend horizontally beyond the corner sections 9 in a way that would prevent passage of a storage container 106 into a storage column 105 defined by the column profiles 102. However, when used in other types of storage systems, e.g. wherein storage containers are introduced into the framework in a different manner, such as horizontally, the configuration of the thermal break may not be restricted in the same manner.

A first set of vertical protrusions 5 extend from the horizontal plate 3 to interact with the rail system 108. The first set of vertical protrusions 5 are arranged at opposite sides of two perpendicular rails 110,111 of the rail system 108 and restrict horizontal movement between the thermal break 2 and the rails 110,111.

A second set of vertical protrusions 4 extend from the horizontal plate 3 to interact with the upper end of the column profile 102. The second set of protrusions 4 are configured to interact with internal surfaces of the hollow centre section 7 of the column profile 102 to restrict horizontal movement between the thermal break 2 and the column profile 102. In alternative embodiments, the second set of protrusions may be configured to interact with external surfaces of the hollow centre section 7.

In the first exemplary embodiment, the vertical protrusions 4,5 are shaped as ribs, however they may have any suitable form, such as pins, provided the function of preventing horizontal movement between the thermal break 2 and the rail system 108 or column profile 102 is obtained.

Alternative configurations of the protrusions 4,5 are contemplated and the first set of protrusions 5 may for instance be configured as an extension of the wall elements 14. In such a configuration, horizontal movement between the thermal break 2 and the rail system may be restricted by interaction with the recess 13 in the rail system 108. The recess 13 is configured to interact with the upper end 10 of a column profile 102 in a framework 100 not comprising thermal breaks 2.

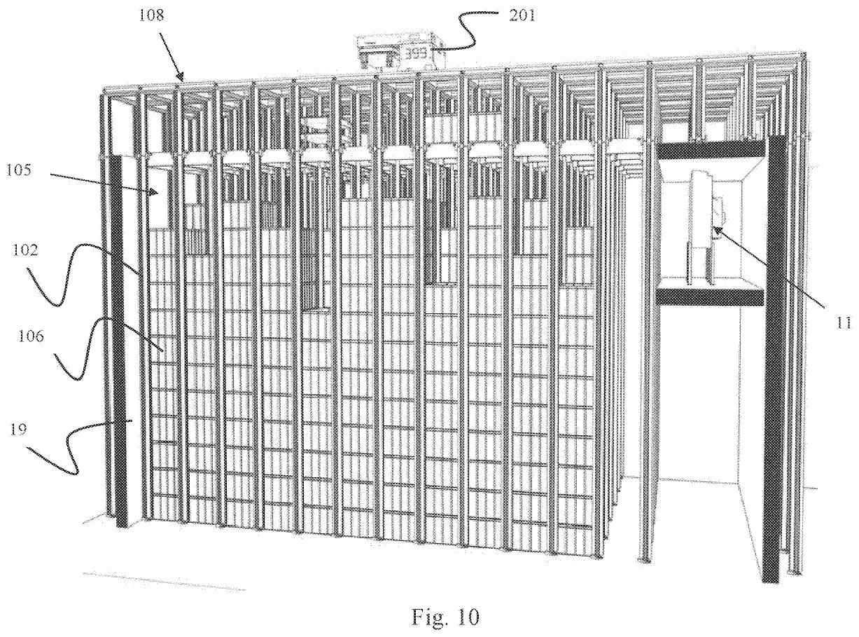

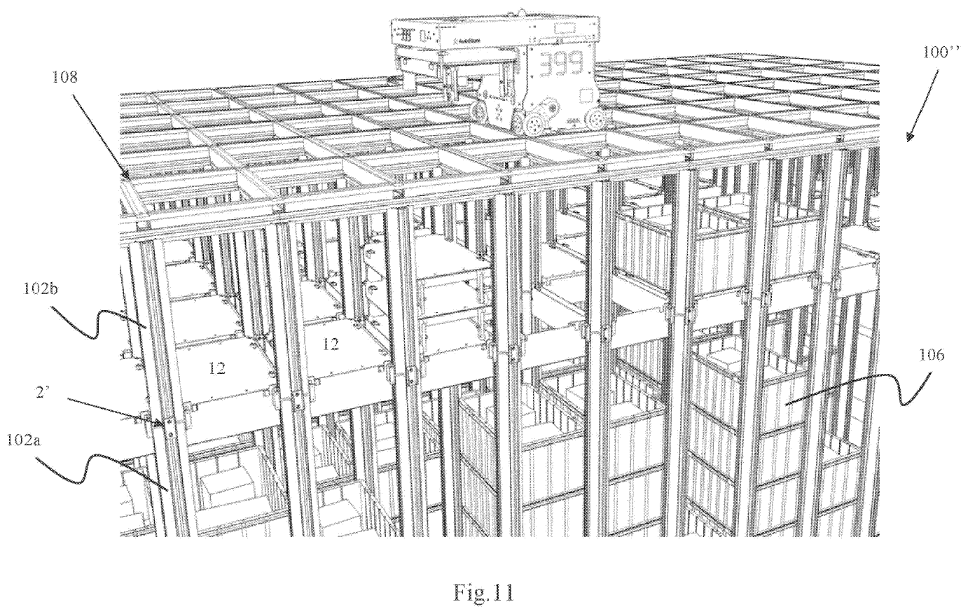

A second exemplary embodiment of a framework structure 100″ according to the invention is shown in FIGS. 10-13. The illustrated framework structure 100″ is part of a cooled storage system comprising a container handling vehicle 201 and a cooling system 11. In the cooled storage system, the column profiles 102 define a plurality of storage columns 105 in which storage containers 106 are stored in stacks on top of one another. The cooled section of storage columns 105 may be insulated from the surroundings, or a non-cooled part of the storage system, by insulating walls 19.

The main differentiating features of the second exemplary embodiment in view of the first exemplary embodiment, is that the column profile 102 comprises a lower profile section 102a and an upper profile section 102b, and the thermal break 2′ is arranged to interconnect the lower profile section 102a and the upper profile section 102b.

In addition to restricting the heat transfer between a lower section of the column profiles, the thermal breaks 2′ of the framework structure 10″ provides connections for a lid arrangement allowing the use of removable lids 12. The lid arrangement is not an essential feature of the present invention and is not described in further detail herein.

The thermal break 2′ comprises a thermal break material as described above.

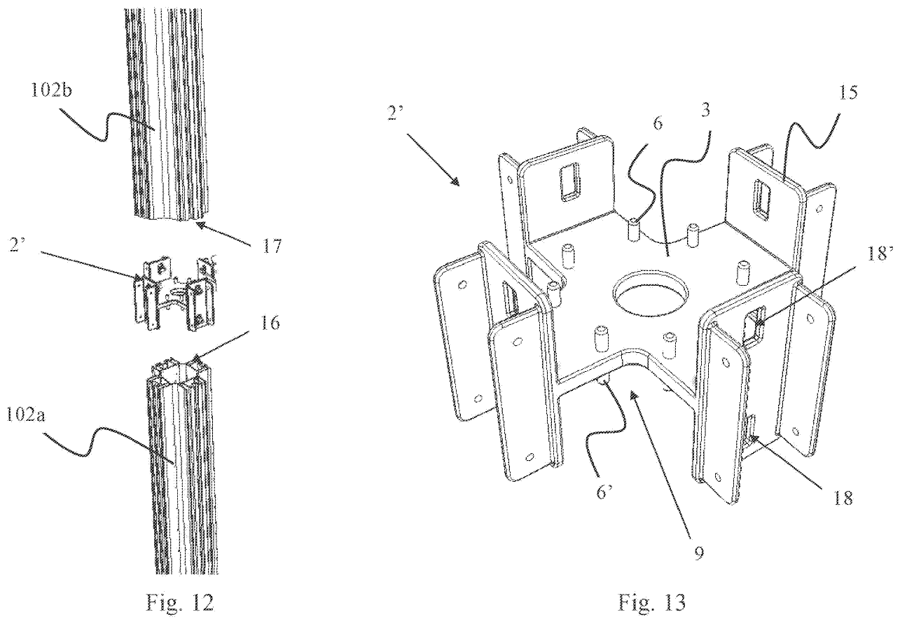

The thermal break 2′, see FIG. 13, features a horizontal plate 3 arranged between the lower profile section 102a and the upper profile section 102b of the column profile 102 (i.e. between the rail system 108 and at least a lower section of the column profile 102). The horizontal plate 3 of each thermal break 2 extends transversely to the respective column profile 102. The horizontal plate 3 may also feature four corner sections 9 fully overlapping the respective four corner sections 8 of the column profile 102. In other words, the horizontal plate does not extend into the four corner sections 8 of the column profile 102.

Vertical protrusions 6,6′ extend from both sides of the horizontal plate 3 to interact with an upper end 16 of the lower profile section 102a and a lower end 17 of the upper profile section 102b. The vertical protrusions 6,6′ ensures that horizontal movement between the thermal break 2′, the lower profile section 102a and the upper profile section 102b is restricted. The vertical protrusions 6,6′ are configured to interact with internal surfaces of the hollow centre section 7 of the respective profile section 102a,102b. To secure the lower profile section 102a to the upper profile section 102b, the thermal break 2′ may comprise profile connecting elements 15. Each of the profile connecting elements 15 features a first through hole 18 for bolt connection to the lower profile section 102a and a second through hole 18′ for connection to the upper profile section 102b.

### LIST OF REFERENCE NUMBERS

1 Prior art automated storage and retrieval system
2 Thermal break
3 Horizontal plate
4 Vertical protrusion, rib
5 Vertical protrusion, rib
6 Vertical protrusion, pin
7 Hollow centre section
8 Corner section (of column profile)
9 Corner section (of thermal break)
10 Uppermost end (of column profile)
11 Flange (of column profile)
12 Lid
13 Recess
14 Wall element
15 Profile connecting element
16 Upper end (of lower profile section)
17 Lower end (of upper profile section)
18,18′ Through hole
19 Insulating wall
100 Framework structure
102 Upright members of framework structure, vertical column profile
102a Lower profile section
102b Upper profile section
105 Storage column
106 Storage container
106′ Particular position of storage container
107 Stack
108 Rail system
110 Parallel rails in first direction (X)
110a First rail in first direction (X)
110b Second rail in first direction (X)
111 Parallel rail in second direction (Y)
111a First rail of second direction (Y)
111b Second rail of second direction (Y)
112 Access opening
119 First port column
120 Second port column
201 Prior art container handling vehicle
201a Vehicle body of the container handling vehicle 201
201b Drive means/wheel arrangement, first direction (X)
201c Drive means/wheel arrangement, second direction (Y)
301 Prior art cantilever container handling vehicle
301a Vehicle body of the container handling vehicle 301
301b Drive means in first direction (X)
301c Drive means in second direction (Y)
304 Gripping device
401 Prior art container handling vehicle
401a Vehicle body of the container handling vehicle 401
401b Drive means in first direction (X)
401c Drive means in second direction (Y)
404 Gripping device
Y Second direction
Z Third direction

1. A framework structure for a storage system, the framework structure comprises a plurality of vertical column profiles and a horizontal rail system supported upon the vertical column profiles, wherein at least a lower section of each of the column profiles is thermally divided from the rail system by a thermal break positioned at each column profile between a lower section of the column profile and a connection to the rail system, the thermal break being configured to restrict thermal conductivity between the lower section of the column profile and the rail system.

2. The framework structure according to claim 1, wherein the column profiles are made in an aluminium alloy and the thermal break comprises a thermal break material having a thermal conductivity lower than 20 W/mK.

3. The framework structure according to claim 1, wherein the thermal break material is a synthetic polymer or wood.

4. The framework structure according to claim 1, wherein the thermal break is configured such that heat being conducted between the lower section of the column profile and the rail system must pass through the thermal break material.

5. The framework structure according to claim 1, wherein the thermal break comprises a horizontal plate arranged between the rail system and at least the lower section of the column profiles.

6. The framework structure according to claim 5, wherein the horizontal plate of each thermal break extends transversely to the column profiles, at a common height arranged between the rail system and at least the lower section of the column profiles.

7. The framework structure according to claim 1, wherein the thermal break comprises vertical protrusions, the vertical protrusions arranged to interact with a surface of the column profile or the rail system to restrict horizontal movement between the thermal break and the column profile or the rail system, respectively.

8. The framework structure according to claim 1, wherein each of the column profiles has a hollow centre section and four corner sections, each corner section defined by a pair of vertically extending, outwardly projecting, perpendicular flanges.

9. The framework structure according to claim 8, wherein the thermal break comprises four corner sections fully overlapping the respective four corner sections of the column profile.

10. The framework structure according to claim 8, wherein the thermal break comprises vertical protrusions arranged to interact with internal or external surfaces of the hollow centre section to restrict horizontal movement between the thermal break and the column profile.

11. The framework structure according to claim 1, wherein the thermal break is arranged at an uppermost end of the column profile, and the rail system is supported on the thermal break.

12. The framework structure according to claim 11, wherein the thermal break comprises vertical protrusions arranged at opposite sides of at least one rail of the rail system, the vertical protrusions restricting horizontal movement between the thermal break and the rail in a direction perpendicular to the longitudinal direction of the rail.

13. The framework structure according to claim 1, wherein the column profile comprises a lower profile section and an upper profile section interconnected via the thermal break.

14. The framework structure according to claim 8, comprising a plurality of storage columns in which storage containers may be stacked on top of one another in vertical stacks, each storage column is defined by one corner section from each of four column profiles, the corner sections arranged to accommodate a corner of a storage container, and the thermal break of each column profile is configured to be flush with or recessed from the corner sections of the column profile such that the corner sections are unobstructed between the rail system and a lower end of the storage column.

15. A storage system for storage containers, the storage system comprising a framework structure for a storage system, the framework structure comprises a plurality of vertical column profiles and a horizontal rail system supported upon the vertical column profiles, wherein at least a lower section of each of the column profiles is thermally divided from the rail system by a thermal break positioned at each column profile between a lower section of the column profile and a connection to the rail system, the thermal break being configured to restrict thermal conductivity between the lower section of the column profile and the rail system, and a plurality of container handling vehicles arranged to operate upon the rail system.

16. The storage system according to claim 15, wherein the vertical column profiles define storage columns in which storage containers are stored on top of one another in vertical stacks.

17. The storage system according to claim 15, comprising a cooling system arranged to provide cooled air to a section of the storage system arranged below the rail system.

18. A method of constructing a framework structure for a cooled storage structure, the framework structure comprising a plurality of vertical column profiles and a rail system upon which container handling vehicles may move in two perpendicular directions, the method comprising:
providing a thermal break for each of the column profiles;
mounting the profile columns to be able to support the rail system;
arranging the thermal breaks at positions to thermally divide at least a lower section of each column profile from the rail system, such that thermal conductivity between at least the lower section of the profile columns and the rail system to be supported by the profile columns is restricted; and
constructing the rail system supported by the profile columns.

19. A method of preventing loss of wheel traction of a container handling vehicle operating on a rail system of a cooled storage system, the cooled storage system comprising a plurality of vertical column profiles upon which the rail system is supported, the method comprises the steps of:
providing a thermal break for each of the column profiles; and
arranging the thermal breaks to thermally divide at least a lower section of each of the column profiles from the rail system, such that thermal conductivity between the lower section of the column profile and the rail system, to which the column profile is connected, is restricted.
